(19) United States
(12) Patent Application Publication
(10) Pub. No.: US 2009/0071881 A1
(43) Pub. Date: Mar. 19, 2009

(54) Method for Production of Bulk Concentrate for Extracting Precious Metals

(76) Inventors: Andrei Filippovich Smetannikov, Perm (RU); Dmitriy Valentinovich Onosov, Perm (RU); Arkadiy Evgenievich Krasnoshtein, Perm (RU)

Correspondence Address: Aleksandr Smushkovich, POB 140505, Brooklyn, NJ, 11214, US

(21) Appl. No.: 12/087,458

(22) PCT Filed: Jan. 9, 2007
(86) PCT No.: PCT/RU2007/000003

§ 371 Date: Jul. 7, 2008

(30) Foreign Application Priority Data
Jan. 10, 2006 (RU) 2006100555

(51) Int. Cl. B07C 5/34

(52) U.S. Cl. 209/629

(57) ABSTRACT

This invention relates to methods for producing bulk concentrate for precious metal recovery from clay-salt residues of plants processing potassium-magnesium ore and rock salt, usable for recovery of components in the form of sedimentary and floated particles, wherein the liquid phase comprises components varying in solubility and density. The method is cost-effective and includes a three-stage hydro-cycloning applied to slimes with S:L=1:3 ratio, carried out sequentially via 10, 7, and 5 degree hydro-cyclones. The bulk concentrate is mixture of sedimentary and floated materials, insoluble in water slimes residue. The second hydro-cyclone discharge, being a salt solution and floated part of the residue with natural and artificially-made organic structure, is forwarded to the third hydro-cyclone for extracting the floated fraction via a discharge fitting and further mixing with concentrates of the first and second hydro-cyclones, formation of the bulk concentrate. The salt solution is extracted via a sand fitting.

### CROSS-REFERENCE TO RELATED APPLICATIONS

This application is a U.S. national phase application of a PCT application PCT/RU2007/000003 filed on 9 Jan. 2007, published as WO2007/100275, whose disclosure is incorporated herein in its entirety by reference, which PCT application claims priority of a Russian Federation patent application RU2006/100555 filed on 10 Jan. 2006.

### FIELD OF THE INVENTION

This invention relates to methods for production of collective concentrate (herein further called ‘bulk concentrate’) for precious metal recovery from clay-salt residues of facilities processing potassium-magnesium ore and rock salt. This invention may be used for the recovery of two or more components in the form of solid particles of various ‘phase’ states, for example, a sedimentary and floated particles, wherein the liquid phase may be presented by two and/or more components varying in solubility and density.

### BACKGROUND AND BRIEF SUMMARY OF THE INVENTION

The method for production of bulk concentrate from clay-salt residue of facilities processing potassium-magnesium ore and rock salt includes hydro-cycloning, which is carried out in three stages. Bulk concentrate of hydro cyclones is a solid phase comprising sedimentary and floated parts, which form an insoluble in water residue (I.R.) of slimes with maximum residual K and Na salt content of 15%. On the stage of the first hydro-cycloning at a solid to liquid ratio S:L=1:3. The concentrate in the form of coarse fraction (I.R.) and a discharge (liquid output) of the first hydro-cyclone in the form of fine fraction of I.R., and a salt solution are extracted. The first hydro-cyclone is de-pulped to a solid to liquid ratio S:L=1:8, and is forwarded to the second stage of hydro-cycloning for re-cleaning in order to extract the concentrate in the form of residual (fine) fraction of I.R. slime. The discharge of the second hydro-cyclone in the form of salt solution and a floated fraction of I.R. is delivered to the third stage of hydro-cycloning, wherein the flotation concentrate is produced via a discharge fitting, and the floated concentrate is formed by mixing with the first and second hydro-cyclones' concentrates. The salt solution which is extracted via a sand fitting of the third hydro-cyclone is represented as a set of tailings. The technological result of the method is the obtaining of the bulk concentrate (I.R.) of slimes with maximum residual K and Na salt content of 15% for a chlorinating roasting with the purpose of recovering Au, Pt, Pd from clay-salt residues (slime).

There are known some methods of classification of crumbled material close to this invention in a technical sense (see, e.g. “Ore dressing guide. V.1. Preliminary processes. M., Nedra, 1972. C.276-278, A. I. Povarov. Hydro cyclones. Moscow, Gosgortekhizdat, 1961.”), related to formation of the rotation of pulp (hydro-cyclones) creating a centrifugal field, wherein the liquid phase is represented by water.

This can be arranged as a result of separation of particles in terms of size, wherein the coarse particles are deduced via a send fitting extracted via a sand fitting, and the fine particles are discharged via drain. Upon the reduction of the sand fitting's cone angle, the fine material may also exit via the fitting, however this material will have a higher density than the major mass of the fine material (A. F. Smetannikov, A. I. Kudryashov. On possibility of gold and silver recovery from Verkhne-Kamskoye salt field/Ores and Metals. 1995. #5. C.118-121). The above methods envisage the separation of solid material in liquid medium based on the size or density of the material. However, the above methods have never been used to separate solid material evenly spread in saturated salt solutions. For instance, residues of potassium production (slimes) are represented by two phases. One phase is a saturated salt solution, whereas the other phase is represented by particles of insoluble residue (I.R.).

There is known a method for production of concentrate from clay-salt residue of facilities processing potassium-magnesium ore and rock salt, aimed at precious metal recovery (Patent of Russian Federation No. 2256504, published on Jul. 20, 2005); the process includes at least two stages of slime hydro-cycloning leading to recovery of the concentrate, wherein the hydro-cycloning is carried out in two or three stages, and the concentrate is represented by a solid phase, i.e. an insoluble residue (I.R.) of slime. The process is carried out at the following conditions: hydro-cycloning is applied to slimes with an S:L ratio of 1:3: on the stage of first hydro-cyclone, where concentrate of the coarse I.R. fraction is produced and the first hydro-cyclone is discharged in the form of fine I.R. fraction and a salt solution. The discharge of the first hydro-cyclone is de-pulped to S:L=1:8 and delivered for re-cleaning at the second stage of hydro-cycloning, which leads to the separation of concentrate in the form of residual fraction of I.R. slime and the second cyclone discharge in the form of salt solution. The above concentrates are combined, and if the residual I.R. content is significant enough, an additional third stage of hydro-cycloning is carried out, thus involving the processing of pulp originating from halurgy (the practice of working with salt) and flotation factories.

A disadvantage of the above method is an insufficient percentage content of precious metals in the concentrate produced from clay-salt residue of the facilities (factories or plants).

### DESCRIPTION OF THE INVENTION

The proposed invention helps resolve the issue of complex cost-efficient recovery of precious metals from mineral raw material such as clay-salt residue (slimes) of potassium production, or marker clays containing chlorides of alkali and alkali-earth elements, containing precious metals.

In order to achieve the above-mentioned technical result the inventive method for production of bulk concentrate from clay-salt residues of facilities processing potassium-magnesium ore or rock salt, for recovery of precious metals includes a three-stage hydro-cycloning leading to concentrate production, wherein the hydro-cycloning is applied to the slimes with a S:L=1:3 ratio; the hydro-cycloning is carried out sequentially via 10, 7, and 5 degree cyclones; and the bulk concentrate from clay-salt residues of the facilities processing potassium-magnesium ore or rock salt for precious metals recovery is a mixture of sedimentary and floated materials, represented by insoluble in water residue of slimes. The discharge of the second hydro-cyclone in the form of salt solution and floated part of insoluble in water slime residue with natural and artificially-produced organic structure is forwarded to the third stage of hydro-cyclone, to provide the extraction via a discharge fitting of floated fraction with natural and artificially-produced organic structure and its further mixing with concentrates of the first and the second hydro cyclones, to form a bulk concentrate, wherein the salt solution extracted via a sand fitting is the tailings of enrichment process, and the slimes to be processed originate from halurgy and floated facilities with high content of natural and artificially-produced organic substances.

The distinctive features of the proposed method compared to the earlier known method closest thereto, is that the hydro-cycloning is carried out sequentially via 10, 7 [symbol] 5 degree cyclones; and the bulk concentrate from clay-salt residues of the facilities processing potassium-magnesium ore or rock salt for precious metals recovery is a mixture of sedimentary and floated materials, represented by insoluble in water residue of slimes. The discharge of the second hydro-cyclone in the form of salt solution and floated part of insoluble slime residue with natural and artificially-produced organic structure is forwarded to the third stage of hydro cyclone, which leads to the extraction via discharge fitting of floated fraction with natural and artificially-produced organic structure and its further mixing with concentrates of the first and the second hydro-cyclones, to form a bulk concentrate, wherein the salt solution extracted via a sand fitting is the tailings of enrichment process, and slimes to be processed are originated from halurgy and floated factories with high content of natural and artificially-produced organic substances.

Due to the availability of the above features, a new method has been developed which enables to produce concentrate with a significant natural and artificially-produced organic content, and a significant content of precious metals.

The proposed method includes three hydro-cyclones with a sequentially decreasing cone angle (10°, 7°, and 5°), to separate solid material evenly spread in liquid medium (saturated salt solutions) and represented by coarse, and fine sedimentary fraction and floated material represented by natural and artificially-produced organic substance.

The results achievable by using [[of]] this method include the most complete separation of two phases of solid material (sediment and floated part) from slime, with maximum residual salt content of 15%. The insoluble residue is a concentrate containing Au, Pt, Pd, the mineral basis of which is formed by (in the descending order) anhydrite, dolomite, quartz, fluorspar, chlorite, hydromica, Fe hydroxides, sulfides, and organic substance represented by natural and artificially-produced organic substances.

The following is required to produce the bulk concentrate:

1) Providing the process of I.R. (concentrate) recovery from clay-salt residues (slimes) by means of hydro-cycloning.
2) As a result of the hydro-cycloning, production of the concentrate with a maximum salt content of 15% for further pyro-metallurgic processing.

The proposed method is applied as follows:

The slimes are passed via a 10° hydro-cyclone, wherein the most coarse part of the I.R. sedimentary fraction is extracted via the sand fitting, and all the fine fraction of I.R., floated material (organic) and salt solution are discharged. The discharge of the 10° hydro-cyclone is delivered to feed the second (7°) hydro-cyclone, wherein the fine fraction of I.R. sedimentary salt is extracted via the sand fitting, and floated material (organic) and salt solution are discharged. The second (7°) hydro-cyclone discharge is delivered to feed the third (5°) hydro-cyclone, wherein the salt solution is extracted via the sand fitting, and the floated material and salt residues are discharged. After that, the first and second hydro-cyclone concentrates are combined with the floated part of I.R. produced via the third hydro-cyclone discharge, to form the bulk concentrate, which is then subject to pyro-processing. Salt content limited by 15%-barrier accumulates during the three stages of hydro-cycloning.

In case of an excessive salt content in the concentrate, re-cleaning is carried out on each stage of hydro-cycloning by means of installing of 10°, 7°, and 5° cyclone pairs on each stage of the hydro-cycloning. In this case, the concentrate produced via the sand fitting of the first 10° hydro-cyclone is delivered to feed the second 10° hydro-cyclone, wherein the concentrate with re-cleaned coarse fraction of I.R. will be extracted via the sand fitting and further delivered to a concentrate receiver tank, whereas discharges of both 10° hydro-cyclones are combined and delivered to feed the first 7° hydro-cyclone. The concentrate from the first 7° hydro-cyclone is delivered to feed the second 7° hydro-cyclone, wherein the re-cleaned concentrate of the fine residual I.R. fraction is extracted via the sand fitting and further delivered to the concentrate receiver tank, whereas the discharges of both 7° hydro cyclones are delivered to feed the first 5° hydro-cyclone. The material, which is extracted via the sand fitting of the first 5° hydro-cyclone, is delivered to feed the second 5° hydro-cyclone, wherein a salt solution cleaned of the floated I.R. part is extracted via the sand fitting; and floated I.R. material residues are discharged to be combined with the discharge of the first 5° hydro-cyclone, and delivered to the concentrate reception tank to form the final bulk concentrate.

The need of such a complicated process chain is derived from the circumstance that the slimes of the potassium-magnesium flotation processing contain significant amounts of natural and artificially created organic substances with a tangible portion of precious metals in contrast to the slimes resulting from the potassium-magnesium ore halurgy processing.

The bulk concentrate, produced from clay-salt residues of facilities processing potassium-magnesium and rock salt, represents slimes halurgy and flotation factories, with density of 1.3 G/cm³ and the S:L=1:3 ratio. The difference is associated with a high content of organic substance, represented by natural organic structure and artificially-produced substance (amines and poly-crylamides). And, if in the case of halurgy factories, the total organic content did not exceed 1.5%, then in our case, the total organic content was 3% due to the introduction of flotation residues in the process, i.e. cyclone dust, with a traditionally high organic content (up to 5%). The aforesaid has conditioned the use of a hydro-cyclone with a 5° conical angle in the third stage of hydro-cycloning, to ensure the complete separation of the floated I.R. fraction. Introduction of this hydro-cyclone in the process chain has resulted in the most complete extraction of the floated I.R. part represented by organic substances with a maximum loss of 5% and has brought to a maximum total loss of 7% of I.R., with the total coefficient of 0.9.

While the invention may be susceptible to embodiment in different forms, there are disclosed in detail hereinabove specific embodiments of the present invention, with the understanding that the present disclosure is to be considered an exemplification of the principles of the invention, and is not intended to limit the invention to that as illustrated and described herein.

1. A method for producing bulk concentrate for precious metal recovery from clay-salt residues of facilities processing potassium-magnesium ore and rock salt, the residues represented by a mixture of sedimentary and floated materials in the form of insoluble in water residue of slimes, said method comprising the steps of:
providing said mixture with a solid-to-liquid ratio of 1:3;
forwarding said mixture to at least one 10 degree first hydro-cyclone;
extracting a coarse fraction concentrate from said first hydro-cyclone;
discharging a fine fraction concentrate and a salt solution from said mixture from said first hydro-cyclone;
de-pulping said mixture in the first hydro-cyclone to a solid to liquid ratio of 1:8;
forwarding the de-pulped mixture with the solid to liquid ratio of 1:8 to at least one 7 degree second hydro-cyclone for re-cleaning;
extracting a remaining fine fraction concentrate from said second hydro-cyclone;
discharging a salt solution and floated part of insoluble in water slime residue with natural and artificially-produced organic structures from said second hydro-cyclone;
forwarding said salt solution and floated part of insoluble in water slime residue with natural and artificially-produced organic structures to at least one 5 degree third hydro-cyclone;
extracting said floated fraction with natural and artificially-produced organic structure from said third hydro-cyclone via a discharge fitting;
extracting said salt solution from said third hydro-cyclone via a sand fitting; and
combining said floated fraction with the coarse fraction concentrate from said first hydro-cyclone and the remaining fine fraction concentrate from said second hydro-cyclone thereby forming the bulk concentrate;
wherein said salt solution being the tailings of an enrichment process.

2. The method, according to claim 1, wherein said slimes originated from halurgy and floated facilities with high content of natural and artificially-produced organic substances.
